(19) United States
(12) Patent Application Publication
(10) Pub. No.: US 2026/0100182 A1
(43) Pub. Date: Apr. 9, 2026

(54) COMPUTER-IMPLEMENTED METHOD FOR FILTERING AT LEAST ONE USEFUL SIGNAL FROM AT LEAST ONE NOISY ACOUSTIC INPUT SIGNAL RECEIVED FROM AT LEAST ONE ACOUSTIC SENSOR

(71) Applicants: ZF Friedrichshafen AG, Friedrichshafen (DE); ZF Mobility Solutions GmbH, Ingolstadt (DE)

(72) Inventors: Jens Giesler, Friedrichshafen (DE); Michael Hertkorn, Bodolz (DE)

(73) Assignees: ZF Friedrichshafen AG, Friedrichshafen (DE); ZF Mobility Solutions GmbH, Ingolstadt (DE)

(21) Appl. No.: 19/351,886

(22) Filed: Oct. 7, 2025

(30) Foreign Application Priority Data
Oct. 8, 2024 (DE) 10 2024 209 783.7

(51) Int. Cl. G10K 11/178

(52) U.S. Cl. CPC G10K 11/17853; G10K 2210/1282; G10K 2210/3028

(57) ABSTRACT

A computer-implemented method for filtering at least one useful signal from at least one noisy acoustic signal of an input signal, includes receiving, from at least one acoustic sensor, the input signal, wherein the at least one useful signal is designed as a siren signal, wherein the input signal is noisy due to wind noise, tire rolling noise, or vehicle internal noise, and a noise component of the input signal masks the at least one useful signal contained in the input signal. The method further includes applying at least one correlation function to the input signal, wherein the correlation function is applied iteratively to result data of the correlation function to increase a signal-to-noise ratio of the input signal.

### CROSS-REFERENCE TO RELATED APPLICATION

This application claims priority to German Patent Application No. 10 2024 209 783.7, filed on Oct. 8, 2024, the entirety of which is hereby fully incorporated by reference herein.

### TECHNICAL FIELD

The present disclosure relates to a computer-implemented method for filtering at least one useful signal from at least one noisy acoustic signal received from at least one acoustic sensor. Furthermore, the present disclosure also relates to a computing device, a system and a vehicle. In addition, the present disclosure relates to a computer program product for filtering at least one useful signal from at least one noisy acoustic signal received from at least one acoustic sensor.

### BACKGROUND ART

Various methods for increasing a signal-to-noise ratio of a noisy acoustic input signal are known from the prior art. These methods can only be used if the input signal detectably has areas without a useful signal and with a useful signal. However, if the useful signal is masked in such a way that it is not detected in the input signal, these methods are basically not applicable. Such masking often occurs, for example, in real signals from more distant sirens that were recorded by acoustic sensors attached to the outside of a fast-moving vehicle.

The prior art is disclosed in US 2022/0363261 A1 und CN 108731886 A.

### SUMMARY

A computer-implemented method for filtering at least one useful signal from at least one noisy acoustic signal received from at least one acoustic sensor is proposed. At least one correlation function is applied to the input signal. The correlation function is applied iteratively to result data of the correlation to increase a signal-to-noise ratio of the input signal.

The method is intended for processing noisy acoustic input signals that were detected by an acoustic sensor arranged on a vehicle, particularly on the outside. Alternatively, it is conceivable that the acoustic sensor is arranged separately from the vehicle on infrastructure elements, such as a traffic light, a traffic sign or the like. The method can be carried out by a computing device, for example a control unit of the vehicle. “Intended” should be understood to mean, specially programmed, specially equipped, and/or specially designed. The fact that an object is intended for a function should be understood to mean that the object performs the function in at least one operating state.

The acoustic sensor preferably comprises at least one microphone to detect the input signal. In particular, the acoustic sensor comprises at least one interface for providing the input signal to the computing device that carries out the method. The interface can be wired or wireless. Preferably, the acoustic sensor comprises at least one analog-to-digital converter to provide the input signal in digital form.

The input signal is noisy due to wind noise, tire rolling noise, in-vehicle noise, or the like. A noise component of the input signal masks the useful signal contained in the input signal, especially in broadband. The useful signal is designed as a siren signal. The useful signal can also be designed as a warning signal, as a traffic control signal or as another signal that appears to be useful to a person skilled in the art.

Preferably, by applying the correlation function to the input signal and to the result data of the correlation, the signal-to-noise ratio of the input signal is increased in such a way that the useful signal stands out clearly from the noise components and can be filtered from the input signal. The signal noise ratio of the input signal may be a ratio of a signal strength of the useful signal to a signal strength of the noise components. In particular, the more often the correlation function is applied, the greater the increase in the signal-to-noise ratio of the input signal.

An iterative application of the correlation function corresponds, to a multiple application of the correlation function, to the result data of the previous correlation. The correlation function is preferably applied to result data at least twice. In particular, the correlation function is applied to the input signal, then the correlation function is applied to the result data of the correlation of the input signal, and then the correlation function is applied to the result data of the correlation of the result data of the input signal.

Depending on the useful signal filtered using the method, special functions of the vehicle can be controlled. For example, a message can be sent to a driver of a vehicle, especially an emergency vehicle. For example, driving functions such as braking and driving to the side of the road can be controlled at least semi-autonomously by the vehicle.

By designing the computer-implemented method according to the present disclosure, a useful signal can be filtered advantageously from a noisy acoustic input signal. Strongly masked useful signals can also be detected advantageously. High traffic safety can be achieved advantageously.

Furthermore, it is proposed that the useful signal be designed as a siren signal. Preferably, an emergency vehicle, such as a medical vehicle, an emergency medical vehicle, a fire engine, a police vehicle, or the like, transmits the siren signal. Alternatively, or additionally, it is conceivable that the siren signal is transmitted by a stationary warning system, for example a disaster warning system. The siren signal can be designed as a siren signal, as a Yelp signal, as a wail signal or as another siren signal that appears to be useful to a person skilled in the art. Strongly masked siren signals can be detected advantageously.

It is further proposed that the correlation function be designed as an autocorrelation function or as a cross-correlation function. A particularly effective correlation can be achieved advantageously.

Furthermore, it is proposed that the correlation function is applied block by block to a certain number of samples of a signal and that the correlation of the entire signal is composed via results of the blocks. Depending on the method step, the signal is the input signal or the result data of the previous correlation. The input signal is preferably continuous in time. Efficient correlation can be achieved advantageously.

It is also proposed that bandpass filtering of the input signal is performed before applying the correlation function. Preferably, corner frequencies of the bandpass are selected in such a way that the useful signal is retained after filtering. Filtering can be further optimized advantageously.

Furthermore, it is proposed that the correlation at least one noise reduction method, which works according to the principle of spectral subtraction of masking components, be applied to the end-result data of the correlation. The end-result data of the correlation corresponds to result data of a last iteration of the correlation. Preferably, the noise reduction method is used to determine spectral properties of the noise or masking in the end-result data. Preferably, the noise reduction method minimizes the determined properties spectrally, through subtraction. A particularly high signal-to-noise ratio can be achieved advantageously.

A computing device is also proposed. The computing device comprises at least one interface for receiving at least one noisy acoustic input signal. The computing device comprises at least one computing module, which is provided to carry out a method according to the present disclosure. The computer module can be designed, as a microprocessor, as an integrated circuit as an FPGA (Field Programmable Gate Array) or as an application-specific integrated circuit (ASIC), or the like. Preferably, the computing device has at least one interface for receiving the measured values from the acoustic sensor. Preferably, the computing device is connected to the acoustic sensor, to the interface of the acoustic sensor, via the interface for data transmission. In particular, the interface is provided for providing the measured values to the computing module. The interface may be wired or wireless. A computing device can be provided to some extent, which enables a high degree of traffic safety.

A system is also proposed. The system comprises at least one computing device according to the present disclosure. The system comprises at least one acoustic sensor, which is intended to detect at least one noisy acoustic input signal and to provide it to the computing device. The computing device is preferably intended for use with the acoustic sensor. In particular, the acoustic sensor may comprise the computing device. For example, the computing device can be designed as a signal processor of the acoustic sensor. Alternatively, it is conceivable that the computing device is designed separately from the acoustic sensor. For example, a control unit (ECU) of a vehicle an electronic control unit, may comprise or form the computing device. The acoustic sensor is preferably connected to the computing device at least in terms of data transmission technology. A system that enables a high degree of road safety can be provided advantageously.

A vehicle is also proposed. The vehicle comprises at least one computing device according to the present disclosure or at least one system according to the present disclosure. The vehicle is preferably designed as an automatically operable vehicle. An “automatically operable vehicle” should, be understood as a vehicle with one of the automation levels 1 to 5 of the SAE J3016 standard. In particular, the automatically operable vehicle has technical equipment that is required for these automation levels. This includes environmental detection sensors, such as at least one acoustic sensor, radar sensors, lidar sensors, and/or cameras, control units, or similar devices. The vehicle is preferably designed as a land vehicle. The vehicle can be designed as a car, preferably as a passenger transport vehicle as an autonomous shuttle, as a truck, as a construction site vehicle, as an agricultural vehicle or as another vehicle that appears to be useful to a person skilled in the art. The vehicle may alternatively be designed as an aircraft, for example as a drone, as an aircraft, as a helicopter, as a vertical take-off and landing aircraft or the like, or as a watercraft, as a ship, as a boat, or the like. Preferably, the vehicle can have a plurality of acoustic sensors distributed over an outer surface of the vehicle. Preferably, in addition to carrying out the method, the computing device the computing module, is intended to control functions of the vehicle, for example at least semi-autonomous driving functions depending on the filtered useful signal. Alternatively, or additionally, it is conceivable that the vehicle has at least one, further computing device that is intended to control the vehicle functions depending on the filtered useful signal. In particular, the computing device can provide the filtered useful signal to the further computing device. A particularly roadworthy vehicle can be provided advantageously.

Furthermore, a computer program product for filtering at least one useful signal from at least one noisy acoustic signal received from at least one acoustic sensor is proposed. The computer program product comprises execution commands which, when the program is executed by a computing device according to the present disclosure, cause it to carry out a method according to the present disclosure. A computer program product that enables a high degree of road safety can be provided advantageously.

The present disclosure is illustrated using an exemplary embodiment in the following figures.

### BRIEF DESCRIPTION OF THE DRAWINGS

FIG. 1 shows a vehicle according to the present disclosure in a schematic representation,

FIG. 2 shows a system according to the present disclosure of the vehicle according to FIG. 1 in a schematic representation,

FIG. 3 shows a flowchart of a method in a schematic representation,

FIG. 4 shows a frequency spectrum of a useful signal in a schematic representation and

FIG. 5 shows a time segment of an input signal in a schematic representation.

### DETAILED DESCRIPTION

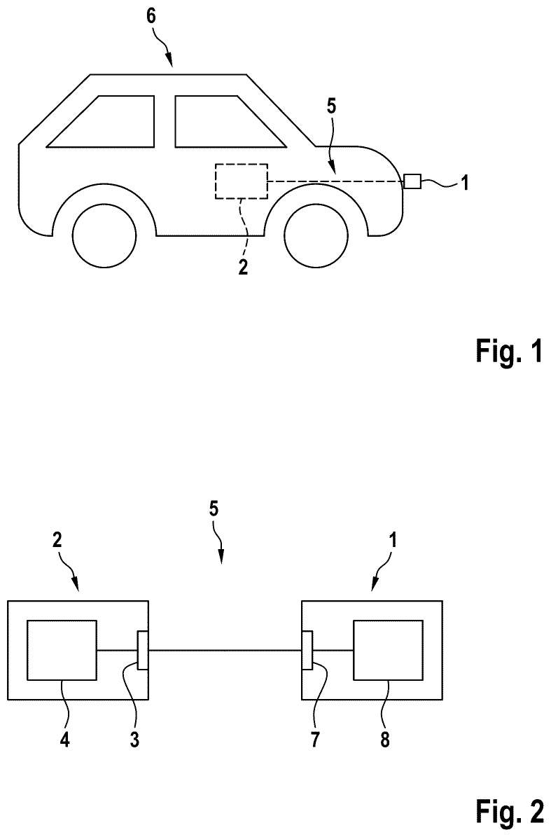

FIG. 1 shows a schematic representation of a vehicle 6. In the present exemplary embodiment, the vehicle 6 is designed as a land vehicle, a passenger car. The vehicle 6 is designed as an automated vehicle. The vehicle 6 comprises at least one computing device 2. The vehicle 6 comprises at least one acoustic sensor 1. The acoustic sensor 1 is arranged on an exterior side of the vehicle 6. The acoustic sensor 1 and the computing device 2 form a system 5. The acoustic sensor 1 is designed to detect at least one noisy acoustic input signal and to provide it to the computing device 2.

FIG. 2 shows the system 5 of the vehicle 6 of FIG. 1 in a schematic representation. In the present exemplary embodiment, the computing device 2 is designed separately from the acoustic sensor 1. The calculating device 2 forms at least part of a control unit, an electronic control unit, of the vehicle 6. The acoustic sensor 1 is connected to the computing device 2 in terms of data transmission technology. The acoustic sensor 1 comprises at least one interface 7 to provide the input signal to the computing device 2. The acoustic sensor 1 comprises at least one microphone 8 to detect the input signal.

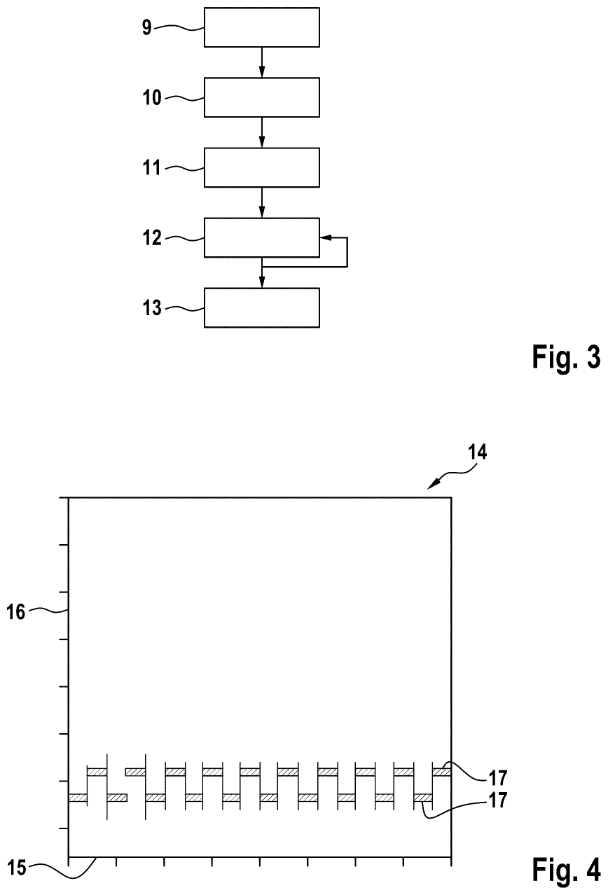

The computing device 2 comprises at least one interface 3 for receiving at least one noisy acoustic input signal. The computing device 2 is connected via the interface 3 to the acoustic sensor 1 to the interface 7 of the acoustic sensor 1. The computing device 2 comprises at least one computing module 4, which is intended to carry out at least one part of the method shown in FIG. 3, a computer-implemented part of the method.

FIG. 3 shows a flowchart of a process in a schematic representation. In a first method step 9, the at least one noisy acoustic input signal is received by the acoustic sensor 1. In a second method step 10 before applying a correlation function, bandpass filtering of the input signal is carried out.

In a third method step 11, the input signal is applied to the least one correction function. In a fourth method step 12, the correlation function is applied to result data of the correlation iteratively, to increase a signal-to-noise ratio of the input signal. The fourth method step 12 can be repeated several times, wherein the correlation function is applied to the result data of the previous correlation.

The useful signal is designed as a siren signal. In the present exemplary embodiment, the siren signal is designed as a siren signal, as shown in FIG. 4. In the present exemplary embodiment, the correlation function is designed as an autocorrelation function. In an alternative exemplary embodiment, the correlation function may also be designed as a cross-correlation function. In the third and fourth method steps 11, 12, the correlation function is applied block by block to a certain number of samples of a signal. The correlation of the entire signal is put together using the results of the blocks. In the third method step 11, the signal is the input signal. In the fourth method step 12, the signal is the result data of the previous correlation.

In a fifth method step 13, the correlation of at least one noise reduction method, which works according to the principle of spectral subtraction of masking components, is applied to the end-result data. The second method step 10, the third method step 11, the fourth method step 12 and the fifth method step 13 form a computer-implemented method for filtering the at least one useful signal from the noisy acoustic input signal received from the acoustic sensor 1. The calculation module 4 is intended to carry out at least the second, third, fourth and fifth method steps 10-13.

Depending on the useful signal filtered using the method, functions of the vehicle 6 can be controlled. The computing device 2, the computing module 4, may be designed not only to execute the computer-implemented method but also to control the functions of the vehicle 6.

A computer program product for filtering at least one useful signal from at least one noisy acoustic input signal received by the acoustic sensor 1 comprises execution commands which, when the program is executed by the computing device 2, cause the computing device 2 to execute the computer-implemented method the second to fifth method steps 10-13.

FIG. 4 shows a frequency spectrum 14 of the useful signal in a schematic representation. Time is plotted on the x-axis 15. Frequency is plotted on the y-axis 16. Horizontal bars 17 indicate the useful signal. The useful signal is designed as a siren signal, for example. The useful signal is composed of two sine tones with a frequency interval of a fourth, which are arranged in sequence with a delay of one second each to form a total signal length.

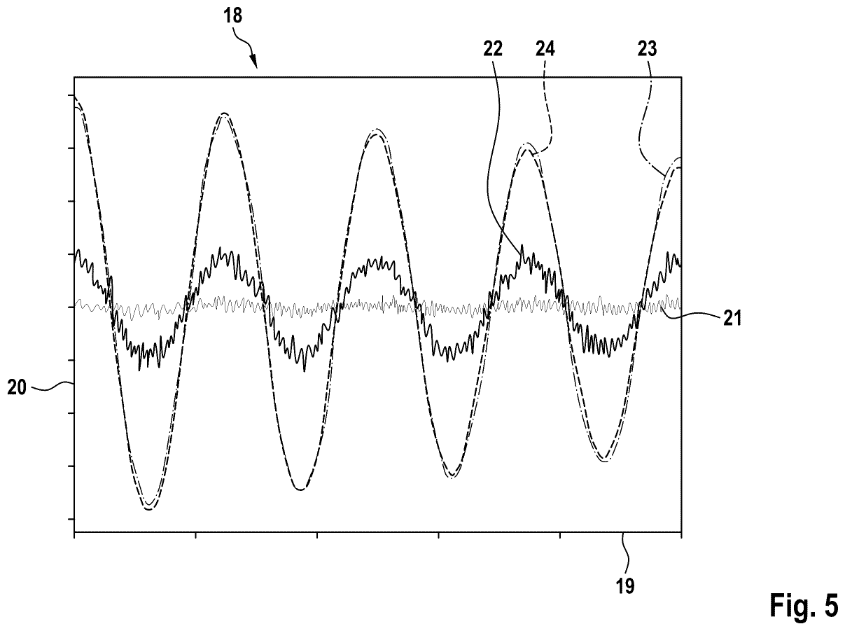

FIG. 5 shows a time segment 18 of an input signal in a schematic representation. A time is applied on an x-axis 19. A signal strength is applied on a y-axis 20. A first curve 21 indicates the input signal as received by the acoustic sensor 1. A second curve 22 characterizes the input signal after applying the correlation function to the input signal. A third curve 23 indicates the input signal after applying the correlation function to the result data of the input signal correlation. A fourth curve 24 indicates the input signal after applying the correlation function to the result data of the correlation of the result data of the input signal.

The input signal received by acoustic sensor 1 is so noisy that the useful signal cannot be distinguished from the noise components. With each iteration of the correlation function, the signal-to-noise ratio of the input signal is further increased, so that the useful signal can be almost completely freed from the noise and filtered out of the input signal.

### REFERENCE SYMBOLS

1 acoustic sensor
2 computing device
3 interface
4 computer module
5 system
6 vehicle
7 interface
8 microphone
9 method step
10 method step
11 method step
12 method step
13 method step
14 frequency spectrum
15 x-axis
16 y-axis
17 bar
18 time segment
19 x-axis
20 y-axis
21 curve
22 curve
23 curve
24 curve

1. A computer-implemented method for filtering at least one useful signal from at least one noisy acoustic signal of an input signal, the method comprising:
receiving, from at least one acoustic sensor, the input signal, wherein the at least one useful signal is designed as a siren signal, wherein the input signal is noisy due to wind noise, tire rolling noise, or vehicle internal noise, and a noise component of the input signal masks the at least one useful signal contained in the input signal; and
applying at least one correlation function to the input signal, wherein the correlation function is applied iteratively to result data of the correlation function to increase a signal-to-noise ratio of the input signal.

2. The computer-implemented method according to claim 1,
wherein the correlation function comprises an autocorrelation function or a cross-correlation function.

3. The computer-implemented method according to claim 1, comprising:
applying the correlation function block by block to a certain number of samples of the input signal, and composing the correlation of an entire input signal over results of the blocks.

4. The computer-implemented method according to claim 1, comprising:
performing bandpass filtering of the input signal before applying the correlation function.

5. The computer-implemented method according to claim 1, comprising:
applying a noise reduction method, operating on a principle of spectral subtraction of masking components, to end-result data of the correlation.

6. A device, comprising:
an interface configured to receive at least a noisy acoustic input signal, wherein at least one useful signal is designed as a siren signal, wherein the noisy acoustic input signal is noisy due to wind noise, tire rolling noise, or vehicle internal noise, and wherein a noise component of the noisy acoustic input signal masks at least one useful signal contained in the input signal; and
a computing device configured to apply at least one correlation function to the noisy acoustic input signal, wherein the correlation function is applied iteratively to result data of the correlation function to increase a signal-to-noise ratio of the input signal.

7. The device according to claim 6, comprising:
at least one acoustic sensor configured to at least detect and provide to the computing device the noisy acoustic input signal.

8. The device according to claim 6,
wherein the correlation function comprises an autocorrelation function or a cross-correlation function.

9. The device according to claim 6,
wherein the computing device is configured to:
apply the correlation function block by block to a certain number of samples of the noisy acoustic input signal, and compose the correlation of an entire noisy acoustic input signal over results of the blocks.

10. The device according to claim 6,
wherein the computing device is configured to:
perform bandpass filtering of the input signal before applying the correlation function.

11. The device according to claim 6,
wherein the computing device is configured to:
apply a noise reduction method, operating on a principle of spectral subtraction of masking components, to end-result data of the correlation.

12. A vehicle comprising:
the device according to claim 6.

13. A non-transitory computer readable medium having stored thereon execution commands that, when executed by a computing device, cause the computing device to execute a method according to claim 1.
